(19) United States
(12) Patent Application Publication
(10) Pub. No.: US 2025/0310947 A1
(43) Pub. Date: Oct. 2, 2025

(54) COMMUNICATION APPARATUS AND COMMUNICATION METHOD

(71) Applicant: Panasonic Holdings Corporation, Osaka (JP)

(72) Inventors: SHOTARO MAKI, Kanagawa (JP); AKIHIKO NISHIO, Osaka (JP); YASUAKI YUDA, Kanagawa (JP)

(21) Appl. No.: 19/041,509

(22) Filed: Jan. 30, 2025

(30) Foreign Application Priority Data
Mar. 29, 2024 (JP) 2024-056616

(51) Int. Cl. H04W 72/0457; H04W 72/0453

(52) U.S. Cl. CPC H04W 72/0457; H04W 72/0453

(57) ABSTRACT

A communication apparatus includes a reception circuitry which, in operation, receives information regarding at least one of a first center frequency of a first frequency band in which a transmitter transmits a signal and a second center frequency of a second frequency band in which a receiver receives the signal, and a control circuitry which, in operation, controls transmission in the first frequency band or reception in the second frequency band based on the information.

### BACKGROUND

### 1. Technical Field

The present disclosure relates to a communication apparatus and a communication method.

### 2. Background Art

Cellular wireless communication such as 5G new radio (NR) access technology is performed.

### SUMMARY

However, there is room for study on a method for improving performance of wireless communication.

In one general aspect, the techniques disclosed here feature a communication apparatus and a communication method capable of improving the performance of wireless communication.

A communication apparatus according to an exemplary embodiment of the present disclosure includes a reception circuitry which, in operation, receives information regarding at least one of a first center frequency of a first frequency band in which a transmitter transmits a signal and a second center frequency of a second frequency band in which a receiver receives the signal, and a control circuitry which, in operation, controls transmission in the first frequency band or reception in the second frequency band based on the information.

It should be noted that general or specific embodiments may be implemented as a system, a method, an integrated circuit, a computer program, a storage medium, or any selective combination thereof.

According to an exemplary embodiment of the present disclosure, the performance of the wireless communication can be improved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram illustrating an example of transmission and reception processing divided into sub-bands;

FIG. 2 is a block diagram illustrating a configuration example of a part of a base station;

FIG. 3 is a block diagram illustrating a configuration example of a part of a terminal;

FIG. 4 is a block diagram illustrating a configuration example of the base station; and

FIG. 5 is a block diagram illustrating a configuration of the terminal.

### DETAILED DESCRIPTION OF PREFERRED EMBODIMENTS

Hereinafter, exemplary embodiments of the present disclosure will be described in detail with reference to the drawings.

In cellular wireless communication including 5G NR, radio waves in a microwave band and a millimeter wave band are utilized. In a sixth generation mobile communication system (6G system), utilization of radio waves in a terahertz band of 100 GHz or more (alternatively, the sub-terahertz band) is further studied. For example, in Kosuke Yamazaki et al., “PROPOSAL FOR A USER-CENTRIC RAN ARCHITECTURE TOWARDS BEYOND 5G”, IEICE Technical Report, vol. 121, no. 189, SAT2021-43, pp. 4-10, October 2021, a system using a terahertz wave for communication near a terminal is proposed.

In a terahertz band, it is assumed that a radio signal is transmitted and received by using a wide radio frequency (RF) frequency bandwidth.

For example, due to the restriction of a transmission circuit, a transmitter may generate a signal by dividing an RF frequency band in which the signal is transmitted into a plurality of RF frequency bands (hereinafter, referred to as “sub-bands”; for example, also referred to as transmission sub-bands). In this case, since local oscillator (LO) leakage (for example, interference due to mixing of a local oscillator signal) may occur at a center frequency of each transmission sub-band (for example, also referred to as a transmission center frequency), reception performance of these frequencies may deteriorate.

In addition, for example, a receiver may perform reception processing of a signal by dividing an RF frequency band in which the signal is received into a plurality of sub-bands (for example, also referred to as reception sub-bands). In this case, due to the influence of a direct current (DC) offset or the like of a reception circuit corresponding to each reception sub-band, reception performance at and/or near DC of the signal after each RF signal of each sub-band is down-converted (for example, at and/or near a center frequency (also referred to as a reception center frequency) of each reception sub-band) may deteriorate.

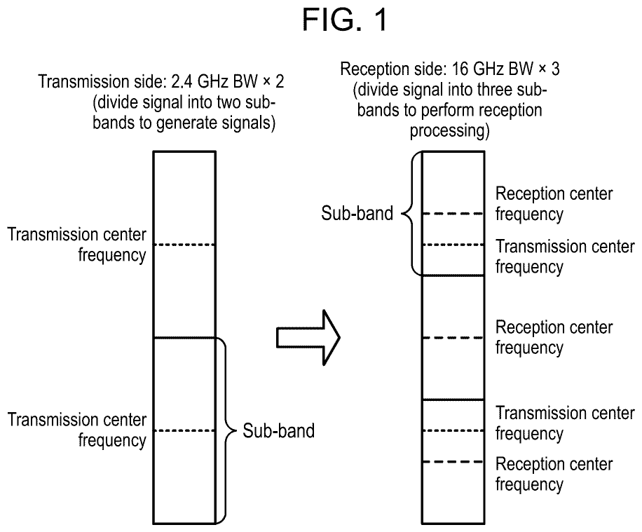

FIG. 1 illustrates an example of processing of dividing the RF frequency band into the sub-bands on each of a transmission side and a reception side.

In the example of FIG. 1, the transmitter generates two RF signals (transmission RF signals) of 2.4 GHz bandwidth in parallel. A total bandwidth of RF signals in two sub-bands (transmission sub-bands) is a 4.8 GHz bandwidth. That is, the transmitter generates a signal in the 4.8 GHz bandwidth by dividing the frequency band into two sub-bands. In addition, in the example of FIG. 1, the receiver receives an RF signal (reception RF signal) having the 4.8 GHz bandwidth by dividing the frequency band into three sub-bands (reception sub-bands) having a 1.6 GHz bandwidth and performing reception processing on the RF signals corresponding to the sub-bands in parallel.

Note that, the presence or absence and method of the sub-band division of the frequency band may depend on the implementation of the transmitter and the receiver. FIG. 1 is an example of the sub-band division method, and the number of sub-bands is not limited to the example in FIG. 1. For example, the number of sub-bands may be the same or different between transmission and reception. In addition, the number of sub-bands may be one (that is, the sub-band division may not be performed).

As described above, the reception quality of a frequency resource (for example, subcarrier) corresponding to a center frequency of each sub-band of the transmission RF signal may deteriorate due to the influence of the LO leakage or the like. In addition, the reception quality of a subcarrier corresponding to a center frequency of each sub-band of the reception RF signal may deteriorate due to the influence of the DC offset or the like.

Generally, since channel estimated values are interpolated or averaged between surrounding subcarriers, an effect of reception quality deterioration at the center frequency also spreads to the surrounding subcarrier of the center frequency. Accordingly, processing for improving reception quality at the center frequency is expected.

In addition, as described above, the presence or absence and method of the sub-band division of the frequency band may depend on the implementation of the transmitter and the receiver. For example, in a case where the transmitter and the receiver do not know each other's center frequencies, it may be impossible to perform the processing for improving the reception quality at the center frequency. A method for sharing information regarding the center frequency of each of the transmitter and the receiver between the transmitter and the receiver has not been fully discussed.

In a non-limiting exemplary embodiment of the present disclosure, the method for improving the reception quality in accordance with the center frequency of the sub-band of each of the transmitter and the receiver will be described. For example, a communication apparatus such as the transmitter and the receiver transmits or receives a signal while avoiding at least one of a center frequency (transmission center frequency) of a frequency band used by the transmitter for transmission (signal generation) and a center frequency (reception center frequency) of a frequency band used by the receiver for reception.

### [Overview of Communication System]

A communication system according to an exemplary embodiment of the present disclosure includes at least one base station 100 (or a gNB or an access point) and terminal 200 (or a mobile station, a user terminal, user equipment (UE), or a station (STA)).

Hereinafter, as an example, an example of data transmission (that is, data transmission in a downlink) from base station 100 to terminal 200 will be described. However, the present disclosure is not limited to the downlink, and may be applied to, for example, data transmission (data transfer) in an uplink from terminal 200 to base station 100.

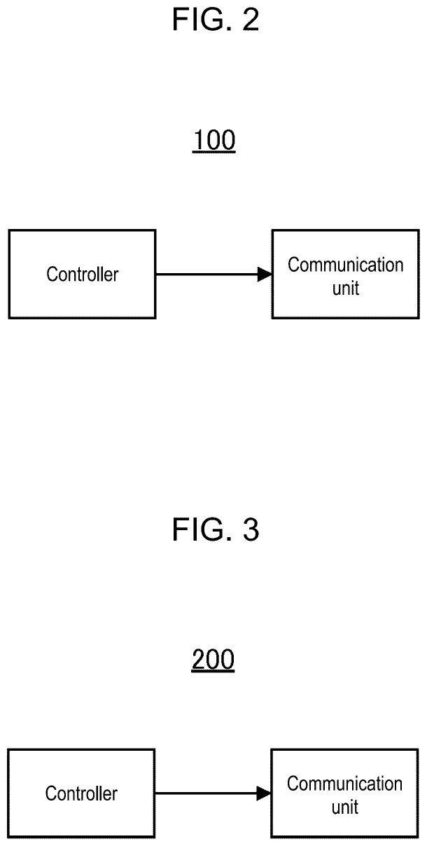

FIG. 2 is a block diagram illustrating a configuration example of a part of base station 100 (for example, corresponding to a communication apparatus). In base station 100 illustrated in FIG. 2, a communication unit (for example, corresponding to reception circuitry) receives information regarding at least one of a first center frequency of a first frequency band in which the transmitter (base station 100 in the downlink and terminal 200 in an uplink) transmits a signal and a second center frequency of a second frequency band in which the receiver (terminal 200 in the downlink and base station 100 in the uplink) receives a signal. A controller (for example, corresponding to control circuitry) controls transmission in the first frequency band or reception in the second frequency band based on the information.

FIG. 3 is a block diagram illustrating a configuration example of a part of terminal 200 (for example, corresponding to a communication apparatus). In terminal 200 illustrated in FIG. 3, a communication unit (for example, corresponding to reception circuitry) receives information regarding at least one of a first center frequency of a first frequency band in which the transmitter (base station 100 in the downlink and terminal 200 in the uplink) transmits a signal and a second center frequency of a second frequency band in which the receiver (terminal 200 in the downlink and base station 100 in the uplink) receives a signal. A controller (for example, corresponding to control circuitry) controls transmission in the first frequency band or reception in the second frequency band based on the information.

### [Configuration Example of Base Station]

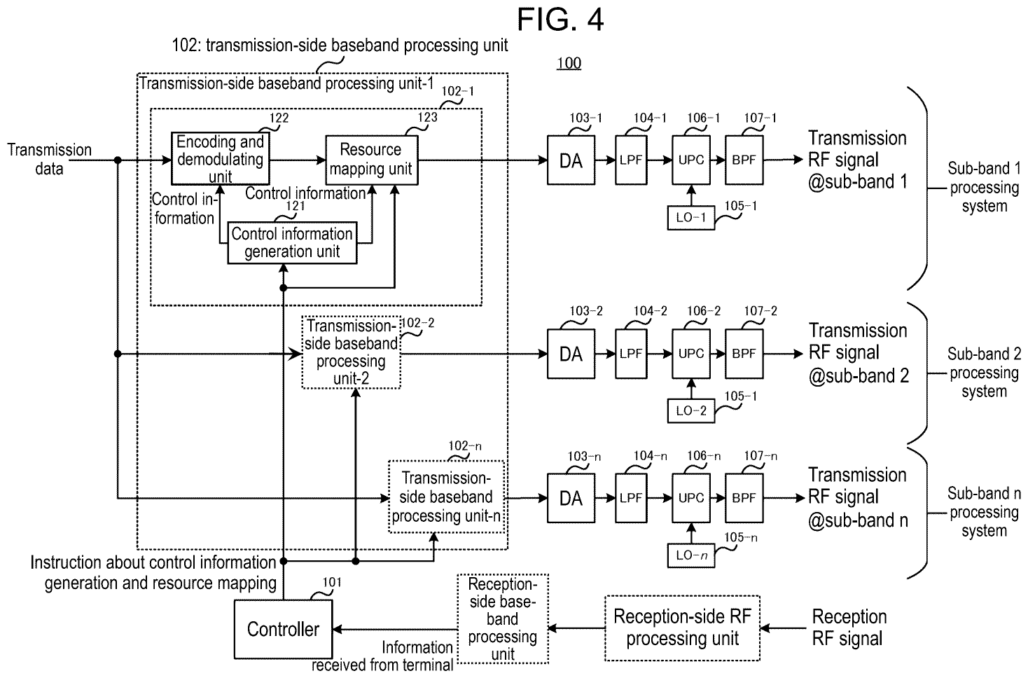

FIG. 4 is a block diagram illustrating an example of a configuration of base station 100 according to the present exemplary embodiment.

In base station 100 illustrated in FIG. 4, transmission-side baseband processing units 102 to band pass filters (BPFs) 107 constitute a “transmission unit” that performs transmission processing of a signal. In addition, base station 100 includes controller 101 that controls transmission processing for the transmission unit.

In addition, for example, the transmission unit of base station 100 illustrated in FIG. 4 may include sub-band processing systems corresponding to a plurality of sub-bands (for example, n sub-bands). Each sub-band processing system may include, for example, transmission-side baseband processing unit 102, DA conversion unit 103, low pass filter (LPF) 104, LO 105, up-converter (UPC) 106, and BPF 107.

In addition, base station 100 includes a “reception unit” that performs reception processing of a signal. The reception unit may include, for example, a reception-side RF processing unit that processes the reception RF signal, and a reception-side baseband processing unit that performs baseband processing on the signal (the signal from terminal 200) after the reception RF processing. Note that, in base station 100, the reception unit may divide the signal into a plurality of sub-bands to receive the signal, similarly to the transmission unit. For example, the reception unit may include sub-band processing systems corresponding to a plurality of sub-bands.

Note that, in FIG. 4, although constituent elements (circuit units) are illustrated by being divided into the processing systems for the sub-bands, the circuit configuration is not limited thereto, and for example, a part or all of transmission-side baseband processing unit 102, DA conversion unit 103, LPF 104, and other circuit units may be shared among the sub-bands.

In addition, for example, at least one of controller 101 and transmission-side baseband processing unit 102 illustrated in FIG. 4 may be included in the controller illustrated in FIG. 2. In addition, at least one of DA conversion units 103 to BPFs 107 illustrated in FIG. 4 may be included in, for example, the communication unit illustrated in FIG. 2.

In FIG. 4, the information received from terminal 200 from the reception unit (for example, reception-side baseband processing unit) is input to controller 101. The information from terminal 200 may include, for example, information regarding the reception center frequency of the reception sub-band in terminal 200. Controller 101 determines a resource to which data is mapped based on, for example, the information from terminal 200, and instructs each transmission-side baseband processing unit 102 (for example, resource mapping unit 123 to be described later) to perform resource mapping. In addition, controller 101 instructs each transmission-side baseband processing unit 102 (for example, control information generation unit 121 to be described later) to generate control information.

Each transmission-side baseband processing unit 102 performs baseband processing on transmission data according to an instruction from controller 101. Transmission-side baseband processing unit 102 may include, for example, control information generation unit 121, encoding and modulating unit 122, and resource mapping unit 123.

Control information generation unit 121 generates the control information according to the instruction from controller 101, and outputs the control information to at least one of encoding and modulating unit 122 and resource mapping unit 123. The control information may include, for example, information regarding the transmission center frequency of the corresponding sub-band.

For example, encoding and modulating unit 122 encodes and modulates the transmission data and the control information input from control information generation unit 121, and outputs the modulated signal to resource mapping unit 123.

For example, according to a resource mapping instruction from controller 101, resource mapping unit 123 maps the signal input from encoding and modulating unit 122 and the control information input from control information generation unit 121 to radio resources, and outputs the mapped signal to DA conversion unit 103. For example, resource mapping unit 123 may map the signal to the resources of the sub-band corresponding to transmission-side baseband processing unit 102.

For example, DA conversion unit 103 converts the baseband signal (a digital signal) input from transmission-side baseband processing unit 102 (for example, resource mapping unit 123) into an analog signal and outputs the analog signal to LPF 104.

For example, LPF 104 performs processing of removing frequency components equal to or higher than a certain frequency band from the analog signal input from DA conversion unit 103 (or processing of allowing desired low-frequency components to pass through), and outputs the signal to UPC 106.

LO 105 generates a LO signal and outputs the LO signal to UPC 106. Here, the frequency of the LO signal is different for each sub-band.

UPC 106 up-converts the frequency of the signal input from LPF 104 to a transmission frequency by using the LO signal input from LO 105, and outputs the signal to BPF 107.

BPF 107 performs processing of removing frequency components other than a specific band (or processing of allowing a specific band component to pass through) among the signal input from UPC 106, and outputs the RF signal. Here, the specific band is different for each sub-band.

### [Configuration Example of Terminal]

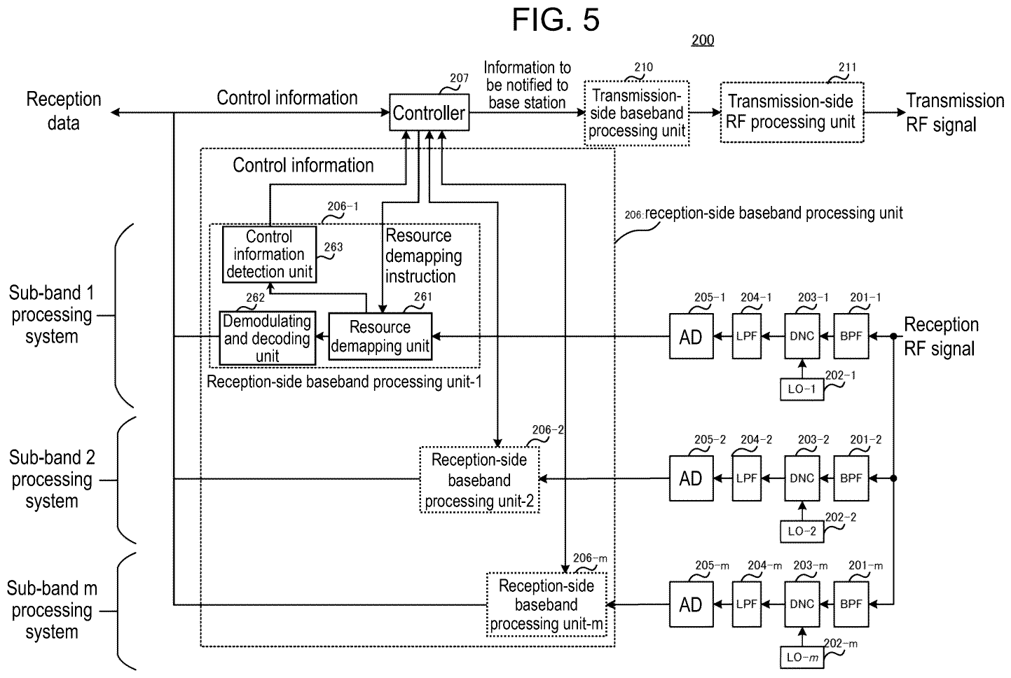

FIG. 5 is a block diagram illustrating an example of a configuration of terminal 200 according to the present exemplary embodiment.

In terminal 200 illustrated in FIG. 5, BPFs 201 to reception-side baseband processing units 206 constitute a “reception unit” that performs reception processing of a signal. In addition, terminal 200 includes controller 207 that controls reception processing for the reception unit.

In addition, for example, the reception unit of terminal 200 illustrated in FIG. 5 may include sub-band processing systems corresponding to a plurality of sub-bands (for example, m sub-bands). Each sub-band processing system may include, for example, BPF 201, LO 202, down-converter (DNC) 203, LPF 204, AD conversion unit 205, and reception-side baseband processing unit 206.

In addition, terminal 200 includes a “transmission unit” that performs transmission processing of a signal. The transmission unit may include, for example, a transmission-side baseband processing unit that performs baseband processing on a signal including transmission data or control information (information to be notified to base station 100), and a transmission-side RF processing unit that performs transmission RF processing on the signal after the baseband processing. The control information may include, for example, the information regarding the reception center frequency of the reception sub-band in terminal 200 (for example, information regarding the center frequency or information regarding the reception signal at the center frequency).

Note that, in terminal 200, the transmission unit may generate a signal by dividing the frequency band into a plurality of sub-bands, similarly to the reception unit. For example, the transmission unit may include sub-band processing systems corresponding to a plurality of sub-bands.

Note that, in FIG. 5, although constituent elements (circuit units) are illustrated by being divided into the processing systems for the sub-bands, the circuit configuration is not limited thereto, and for example, a part or all of reception-side baseband processing unit 206, AD conversion unit 205, LPF 204, and other circuit units may be shared among the sub-bands.

In addition, for example, at least one of reception-side baseband processing unit 206 and controller 207 illustrated in FIG. 5 may be included in the controller illustrated in FIG. 3. In addition, at least one of BPF 201 to AD conversion unit 205 illustrated in FIG. 5 may be included in, for example, the communication unit illustrated in FIG. 3.

In FIG. 5, BPF 201 performs processing of removing frequency components other than a specific band from the reception RF signal (or processing of extracting a specific frequency band component), and outputs the processed signal to DNC 203. Here, the frequency band to be extracted is different for each sub-band.

LO 202 generates a LO signal and outputs the signal to DNC 203. Here, the frequency of the LO signal is different for each sub-band.

DNC 203 down-converts the signal input from BPF 201 by using the LO signal input from LO 202, and outputs the signal to LPF 204.

For example, LPF 204 performs processing of removing frequency components equal to or higher than a certain frequency band from the analog signal input from DNC 203 (or processing of allowing desired low-frequency components to pass through), and outputs the signal to AD conversion unit 205.

For example, AD conversion unit 205 converts the analog signal input from LPF 204 into a baseband signal (a digital signal) and outputs the baseband signal to reception-side baseband processing unit 206 (for example, resource demapping unit 261).

Each reception-side baseband processing unit 206 performs baseband processing on the reception signal from base station 100 (the signal input from AD conversion unit 205) according to instruction from controller 207. Reception-side baseband processing unit 206 may include, for example, resource demapping unit 261, demodulating and decoding unit 262, and control information detection unit 263.

Resource demapping unit 261 extracts a data signal and a control signal from the signal input from the AD conversion unit 205 according to a resource demapping instruction from controller 207. Resource demapping unit 261 outputs the extracted data signal to demodulating and decoding unit 262, and outputs the control signal to control information detection unit 263. For example, resource demapping unit 261 may extract signals from resources of a sub-band corresponding to reception-side baseband processing unit 206.

Demodulating and decoding unit 262 demodulates and decodes the data signal input from resource demapping unit 261, and extracts reception data and control information. Demodulating and decoding unit 262 outputs the extracted control information to controller 207.

Control information detection unit 263 extracts the control information from the control signal input from resource demapping unit 261, and outputs the control information to controller 207. The control information may include, for example, the information regarding the transmission center frequency of the transmission sub-band in base station 100.

Controller 207 determines a resource demapping method based on the control information input from reception-side baseband processing unit 206 (for example, demodulating and decoding unit 262 or control information detection unit 263), and instructs resource demapping unit 261 on the determined method. In addition, controller 207 determines information to be notified to base station 100, and outputs the information to be notified to the transmission unit (for example, transmission-side baseband processing unit).

### [Operation Examples of Base Station 100 and Terminal 200]

Next, operation examples of base station 100 and terminal 200 will be described.

Hereinafter, Operation Examples 1 and 2 will be described.

### Operation Example 1

In Operation Example 1, base station 100 and terminal 200 do not transmit or receive a signal in a frequency resource (for example, subcarrier) corresponding to at least one of the transmission center frequency and the reception center frequency. For example, base station 100 and terminal 200 transmit or receive a signal in a frequency resource different from the frequency resource (for example, subcarrier) corresponding to at least one of the transmission center frequency and the reception center frequency.

### Operation Example 1-1

In Operation Example 1-1, terminal 200 that is the reception side notifies base station 100 that is the transmission side of the information regarding the reception center frequency of each reception sub-band.

Base station 100 does not map the signal (for example, data or reference signal (RS)) to the frequency resource (for example, subcarrier) corresponding to the reception center frequency notified from terminal 200. For example, base station 100 maps the data or the RS to a frequency resource different from the frequency resource corresponding to the reception center frequency notified from terminal 200. As described above, base station 100 (for example, transmitter) receives the information regarding the reception center frequency from terminal 200 (receiver) and controls signal transmission in frequency resources different from the reception center frequency.

Hereinafter, operation examples of base station 100 and terminal 200 in Operation Example 1-1 will be described.

### (ST101)

Terminal 200 notifies base station 100 of the information regarding the reception center frequency of each reception sub-band of terminal 200. A signal used for the notification of the information regarding the reception center frequency may be, for example, an uplink physical layer signal (for example, uplink control information (UCI) or channel state information (CSI)), an upper layer signal (for example, radio resource control (RRC) or media access control (MAC), or another signal. In addition, a resource used for the notification of the information regarding the reception center frequency may be, for example, a physical random access channel (PRACH), a physical uplink control channel (PUCCH), a physical uplink shared channel (PUSCH), or another channel.

### (ST102)

Base station 100 identifies the center frequency of each reception sub-band in terminal 200 based on the signal received from terminal 200.

### (ST103)

Base station 100 maps a downlink data signal and an RS for terminal 200 to another frequency resource different from the frequency resource (for example, subcarrier) corresponding to the reception center frequency (and/or near the reception center frequency) identified in the processing of (ST102) and transmits the data signal and the RS to terminal 200.

### (ST104)

Terminal 200 receives the data signal and the RS from base station 100.

As described above, terminal 200 notifies base station 100 of the information regarding the reception center frequency in terminal 200, and base station 100 transmits data without using the frequency resource at and/or near the reception center frequency in terminal 200. As a result, for example, as illustrated in FIG. 1, even in a case where the configuration of the transmission sub-band is different from the configuration of the reception sub-band, base station 100 identifies the frequency resource at and/or near the reception center frequency of terminal 200 and transmits the signal while avoiding the frequency resource, and thus, terminal 200 can receive data by reducing, for example, the influence of the DC offset or the like that may occur at and/or near the reception center frequency. As a result, the reception quality is improved.

Note that, although the data transmission in the downlink has been described above, Operation Example 1-1 may be applied to the data transmission in the uplink. For example, in the processing of (ST103), base station 100 that is the reception side in the uplink may transmit a grant signal (for example, including information that can identify the reception center frequency) for scheduling the uplink data transmission to terminal 200 that is the transmission side in the uplink. In addition, for example, in the processing of (ST104), terminal 200 may transmit the uplink data signal and the RS based on the grant signal. At this time, terminal 200 may map the uplink data signal and the RS to the frequency resource different from the frequency resource corresponding to the reception center frequency of each reception sub-band of base station 100 (and/or near the reception center frequency).

### Operation Example 1-2

In Operation Example 1-2, base station 100 that is the transmission side notifies terminal 200 that is the reception side of the information regarding the transmission center frequency of each transmission sub-band.

Terminal 200 does not use the frequency resource (for example, subcarrier) corresponding to the transmission center frequency notified from base station 100 for reception processing (for example, channel estimation or the like). For example, terminal 200 uses the frequency resource different from the frequency resource corresponding to the transmission center frequency for the reception processing. As described above, terminal 200 (for example, receiver) receives the information regarding the transmission center frequency from base station 100 (transmitter), and controls signal reception in the frequency resource different from the transmission center frequency.

Hereinafter, operation examples of base station 100 and terminal 200 in Operation Example 1-2 will be described.

### (ST201)

Base station 100 notifies terminal 200 of the information regarding the transmission center frequency of each transmission sub-band of base station 100. A signal used for the notification of the information regarding the transmission center frequency may be, for example, a downlink physical layer signal (for example, downlink control information (DCI)), an upper layer signal, or another signal. In addition, a resource used for the notification of the information regarding the transmission center frequency may be a physical downlink control channel (PDCCH), a physical downlink shared channel (PDSCH), or another channel.

### (ST202)

Base station 100 maps the downlink data signal and the RS for terminal 200 to another frequency resource different from the frequency resource (for example, subcarrier) corresponding to the transmission center frequency of each transmission sub-band of base station 100 (and/or near the transmission center frequency), and transmits the downlink data signal and the RS to terminal 200.

### (ST203)

Terminal 200 receives the data signal and the RS from base station 100. At this time, terminal 200 performs reception processing (for example, channel estimation) without using the frequency resource (for example, subcarrier) corresponding to the transmission center frequency (and/or near the transmission center frequency) notified in the processing of (ST201).

As described above, base station 100 notifies terminal 200 of the information regarding the transmission center frequency in base station 100, and terminal 200 receives data without using frequency resources at and/or near the transmission center frequency in base station 100. As a result, for example, as illustrated in FIG. 1, even in a case where the configuration of the transmission sub-band is different from the configuration of the reception sub-band, the terminal identifies the frequency resource at and/or near the transmission center frequency of base station 100 and receives the signal while avoiding the frequency resource, and thus, the terminal can receive data by reducing the influence of the LO leakage, the DC offset, or the like that may occur at and/or near the transmission center frequency. As a result, the reception quality is improved.

Note that, although the data transmission in the downlink has been described above, Operation Example 1-2 may be applied to the data transmission in the uplink. For example, in the processing of (ST202), base station 100 that is the reception side in the uplink may transmit a grant signal for scheduling the uplink data transmission to terminal 200. In addition, for example, in the processing of (ST203), terminal 200 may transmit the uplink data signal and the RS based on the grant signal. At this time, terminal 200 may notify base station 100 of the information regarding the transmission center frequency of the transmission sub-band of terminal 200. Base station 100 may perform reception processing without using the frequency resource corresponding to the transmission center frequency of each transmission sub-band of terminal 200 (and/or near the transmission center frequency).

### Combination of Operation Example 1-1 and Operation Example 1-2

For example, in Operation Example 1-1, the information regarding the reception center frequency may be notified from terminal 200 to base station 100, and the information regarding the transmission center frequency may be notified from base station 100 to terminal 200. At this time, in the processing of (ST103), base station 100 may map the data signal and the RS to frequency resources different from frequency resources corresponding to both the reception center frequency and the transmission center frequency. In addition, terminal 200 may perform the reception processing without using the frequency resources corresponding to both the transmission center frequency and the reception center frequency. Note that, in the case of not only the downlink transmission but also the uplink transmission, similarly, the information regarding the reception center frequency may be notified from base station 100 to terminal 200, and the information regarding the transmission center frequency may be notified from terminal 200 to base station 100.

In addition, in Operation Example 1-2, the information regarding the transmission center frequency may be notified from base station 100 to terminal 200, and the information regarding the reception center frequency may be notified from terminal 200 to base station 100. At this time, in the processing of (ST202), base station 100 may map the data signal and the RS to frequency resources different from frequency resources corresponding to both the transmission center frequency and the reception center frequency. In addition, terminal 200 may perform the reception processing without using the frequency resources corresponding to both the transmission center frequency and the reception center frequency. Note that, in the case of not only the downlink transmission but also the uplink transmission, similarly, the information regarding the reception center frequency may be notified from base station 100 to terminal 200.

### <Information of Frequency Resources to be Notified>

In Operation Example 1, the information notified as the frequency resource corresponding to the center frequency may be, for example, a subcarrier index, a resource block (RB) index, or an index representing another frequency unit. In addition, for example, a method of sub-band division may be notified instead of the information regarding the frequency resources. As a result, the center frequency may be implicitly notified.

### <Notification of Guard Band Resource Between Sub-Bands>

In Operation Example 1, information regarding a resource of a guard band between the transmission sub-bands may be notified from the transmission side to the reception side. In addition, information regarding a resource of a guard band between the reception sub-bands may be notified from the reception side to the transmission side. As a result, deterioration in reception quality due to the guard band can be prevented. In addition, for example, base station 100 and terminal 200 may identify sub-band division (or sub-band configuration) in a communication partner based on information regarding a resource of a guard band of the communication partner and may identify a center frequency of each sub-band. That is, the center frequency may be implicitly notified by the information regarding the resource of the guard band.

### Operation Example 2

In Operation Example 2, the receiver notifies (or feedbacks) the transmitter of the information regarding the reception signal of the transmission center frequency of the transmitter (and/or near the transmission center frequency). In addition, the transmitter corrects the transmission circuit of the transmitter based on the information regarding the reception signal notified from the receiver.

For example, in the downlink transmission, terminal 200 that is the reception side notifies base station 100 of the information regarding the reception signal at and/or near the transmission center frequency of each transmission sub-band of base station 100 that is the transmission side. Base station 100 corrects the transmission circuit based on the notified information regarding the reception signal.

Hereinafter, operation examples of base station 100 and terminal 200 in Operation Example 2 will be described.

### (ST301)

Base station 100 notifies terminal 200 of the information regarding the transmission center frequency of each transmission sub-band of base station 100. A signal used for the notification of the information regarding the transmission center frequency may be, for example, a downlink physical layer signal, an upper layer signal, or another signal. In addition, a resource used for the notification of the information regarding the transmission center frequency may be, for example, a PDCCH, a PDSCH, or another channel.

### (ST302)

Base station 100 transmits the data signal and the RS to terminal 200. Terminal 200 receives the data signal and the RS from base station 100.

### (ST303)

Terminal 200 notifies (feeds back) base station 100 of the information regarding the reception signal at the transmission center frequency (for example, subcarrier) notified in the processing of (ST302) among the data signal received in the processing of (ST301). The information notified to base station 100 may include, for example, any one of the following pieces of information or other information.
Information (for example, degree of deterioration in reception quality) indicating reception quality (for example, Block Error Rate (BLER) or Signal to Interference and Noise Ratio (SINR)) in subcarrier
Information (for example, magnitude (absolute value or relative value) of interference signal such as LO leakage) regarding interference in subcarrier
Information regarding correction amount of transmission circuit (for example, estimated amount of DC offset in transmission circuit)

### (ST304)

Base station 100 corrects the transmission circuit based on the information received in the processing of (ST303). The correction of the transmission circuit may include, for example, correction processing for suppressing the LO leakage at the transmission center frequency or correction processing for correcting the DC offset. Then, base station 100 transmits the data signal or the RS to terminal 200 by using the corrected transmission circuit. At this time, base station 100 may map the signal to the frequency resource corresponding to the transmission center frequency of each transmission sub-band, and may transmit the signal.

As described above, base station 100 transmits the data signal at the transmission center frequency of the corrected transmission circuit, and thus, terminal 200 can receive the data signal while reducing the influence of the LO leakage, the DC offset, or the like that may occur at and/or near the transmission center frequency. As a result, the reception quality is improved. In addition, according to Operation Example 2, since data can be mapped near the transmission center frequency, resource utilization efficiency is improved as compared with Operation Example 1.

Note that, although the data transmission in the downlink has been described above, Operation Example 2 may be applied to the data transmission in the uplink. For example, terminal 200 that is the uplink transmission side may transmit the information regarding the transmission center frequency of the transmission sub-band to base station 100 that is the reception side in the uplink, and base station 100 may notify (feed back) terminal 200 of the information regarding the reception signal at the notified transmission center frequency (for example, subcarrier). Terminal 200 may correct the transmission circuit based on the received information.

As described above, in the present exemplary embodiment, base station 100 and terminal 200 receive the information regarding at least one of the transmission center frequency of the transmitter and the reception center frequency of the receiver, and control transmission in the transmission frequency band or reception in the reception frequency band based on the received information. As a result, for example, even in a case where the presence or absence of the sub-band division of the frequency band and the method depend on the implementation of the transmitter and the receiver, since base station 100 and terminal 200 can identify the center frequency of the frequency band (for example, sub-band) of the communication partner and can control the transmission and reception of the signal, the reception quality on the reception side can be improved. Therefore, according to the present exemplary embodiment, the performance of wireless communication can be improved.

The exemplary embodiment of the present disclosure has been described above.

Note that, in the above exemplary embodiment, in a case where the subcarrier specified (or configured) in advance as the frequency resource for transmitting the RS overlaps (or collides with) the transmission center frequency or the reception center frequency, base station 100 or terminal 200 may stop the transmission of the RS. Alternatively, base station 100 or terminal 200 may transmit the RS (that is, shift the transmission subcarrier of the RS) on another frequency resource. Since the number of received RSs is not reduced due to the shift of the frequency resources for transmitting the RSs, the reception quality is improved.

In addition, the radio frequency may also be referred to as a carrier frequency.

Although the microwave band, the millimeter wave band, and the terahertz band (or the sub-terahertz band) have been described as examples of the radio frequency band, the present disclosure is not limited thereto, and the frequency band used for the transmission or the reception in base station 100 and terminal 200 may be another frequency band or a combination of these frequency bands.

In addition, in the above exemplary embodiment, the notation “unit” may be replaced with another notation such as “ . . . circuit (circuitry)”, “ . . . device”, “ . . . unit” or “ . . . module”.

### (Control Signal)

In the above exemplary embodiment, the control signal may be a PDCCH that transmits DCI of a physical layer, or may be an upper layer signal (for example, MAC or RRC). In addition, the data signal may include an upper layer signal.

In addition, the PDCCH in the above operation example may be transmitted in Common Search Space or UE Specific Search Space.

### (Base Station)

In the present exemplary embodiment, the base station may be a transmission reception point (TRP), a cluster head, an access point, a remote radio head (RRH), an eNodeB (eNB), a gNodeB (gNB), a base station (BS), a base transceiver station (BTS), a master unit, a gateway, or the like. In addition, in sidelink communication, a terminal may be used instead of a base station.

### (Uplink and Downlink)

In the above exemplary embodiment, although the downlink has been described as an example, the present disclosure can also be applied to the PUSCH in the uplink. For example, the PDCCH in the operation example may be a PUCCH.

### (Data Channel and Control Channel)

In the above exemplary embodiment, the resource of the PDSCH or the PUSCH may be allocated by the PDCCH, or may be a resource configured by an upper layer signal.

### (Reference Signal)

In the above exemplary embodiment, reference signal RS is, for example, a signal known by both the base station and the mobile station, and may be also referred to as a reference signal (RS) or a pilot signal. For example, the reference signal may be any of a DMRS, a channel state information-reference signal (CSI-RS), a tracking reference signal (TRS), a phase tracking reference signal (PTRS), a sounding reference signal (SRS), and a cell-specific reference signal (CRS).

### (Time Interval)

In the above exemplary embodiment, a unit of a time resource is not limited to one or a combination of a slot and a symbol, and may be, for example, a unit of a time resource such as a frame, a super frame, a subframe, a slot, a timeslot subslot, a mini-slot, or a symbol, an orthogonal frequency division multiplexing (OFDM) symbol, or a single carrier-frequency division multiplexing (SC-FDMA) symbol or may be other time resource units. In addition, the number of symbols included in one slot is not limited to the number of symbols exemplified in the above-described exemplary embodiment, and may be other numbers of symbols.

### (Application to Sidelink)

The above exemplary embodiment may also be applied to communication using sidelink used for vehicle to everything (V2X) or terminal-to-terminal communication. In this case, the PDCCH may be a physical sidelink control channel (PSCCH), the PUSCH/PDSCH may be a physical sidelink shared channel (PSSCH), and the PUCCH may be a physical sidelink feedback channel (PSFCH).

### (Licensed Band and Unlicensed Band)

The above exemplary embodiment may also be applied to communication in a licensed band and an unlicensed band (unlicensed spectrum or shared spectrum). In the case of the unlicensed band, a channel access procedure (Listen Before Talk (LBT), Carrier Sense, Channel Clear Assessment (CCA)) may be performed before each signal is transmitted.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas. Some non-limiting examples of such communication apparatus include a phone (e.g., cellular (cell) phone, smart phone), a tablet, a personal computer (PC) (e.g., laptop, desktop, notebook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A communication apparatus according to an exemplary embodiment of the present disclosure includes a reception circuitry which, in operation, receives information regarding at least one of a first center frequency of a first frequency band in which a transmitter transmits a signal and a second center frequency of a second frequency band in which a receiver receives the signal, and a control circuitry which, in operation, controls transmission in the first frequency band or reception in the second frequency band based on the information.

In an exemplary embodiment of the present disclosure, the communication apparatus is the transmitter, the reception circuitry, in operation, receives the information regarding the second center frequency from the receiver, and the control circuitry, in operation, controls transmission of the signal in a frequency resource different from the second center frequency.

In an exemplary embodiment of the present disclosure, the communication apparatus is the transmitter, the reception circuitry, in operation, receives the information regarding the second center frequency from the receiver, and the control circuitry, in operation, does not map the signal to a frequency resource corresponding to the second center frequency, and maps the signal to another frequency resource different from the frequency resource corresponding to the second center frequency.

In an exemplary embodiment of the present disclosure, the communication apparatus is the transmitter, the communication apparatus further includes a transmission circuitry, the reception circuitry, in operation, receives the information regarding the second center frequency from the receiver, the transmission circuitry, in operation, transmits the information regarding the first center frequency to the receiver, and the control circuitry, in operation, does not map the signal to frequency resources corresponding to the first center frequency and the second center frequency, and maps the signal to other frequency resources different from the frequency resources corresponding to the first center frequency and the second center frequency.

In an exemplary embodiment of the present disclosure, the communication apparatus is the receiver, the reception circuitry, in operation, receives the information regarding the first center frequency from the transmitter, and the control circuitry, in operation, controls reception of the signal in a frequency resource different from the first center frequency.

In an exemplary embodiment of the present disclosure, the communication apparatus is the receiver, the reception circuitry, in operation, receives the information regarding the first center frequency from the transmitter, and the control circuitry, in operation, does not use a frequency resource corresponding to the first center frequency for reception processing, and uses another frequency resource different from the frequency resource corresponding to the first center frequency for reception processing.

In an exemplary embodiment of the present disclosure, the communication apparatus is the receiver, the communication apparatus further includes a transmission circuitry, the reception circuitry, in operation, receives the information regarding the first center frequency from the transmitter, the transmission circuitry, in operation, transmits the information regarding the second center frequency to the transmitter, and the control circuitry, in operation, does not use frequency resources corresponding to the first center frequency and the second center frequency for reception processing, and uses other frequency resources different from the frequency resources corresponding to the first center frequency and the second center frequency for reception processing.

In an exemplary embodiment of the present disclosure, the communication apparatus is the transmitter, the reception circuitry, in operation, receives information regarding a reception signal at the first center frequency from the receiver, and the control circuitry, in operation, corrects a transmission circuitry of the transmitter based on the information regarding the reception signal.

In an exemplary embodiment of the present disclosure, the information regarding the reception signal includes reception quality at the first center frequency, a value indicating interference at the first center frequency, or a correction amount of the transmission circuitry.

In an exemplary embodiment of the present disclosure, the control circuitry, in operation, performs correction processing of suppressing LO leakage or correction processing of correcting a DC offset at a transmission center frequency of the transmitter based on the information regarding the reception signal.

In an exemplary embodiment of the present disclosure, the communication apparatus is the transmitter, the communication apparatus further includes a transmission circuitry, the transmission circuitry, in operation, transmits the information regarding the first center frequency to the receiver, the reception circuitry, in operation, receives information regarding a reception signal at the first center frequency from the receiver, and the control circuitry, in operation, corrects a characteristic of the transmission circuitry based on the information regarding the reception signal.

A communication method according to an exemplary embodiment of the present disclosure includes, receiving, by a communication apparatus, information regarding at least one of a first center frequency of a first frequency band in which a transmitter transmits a signal and a second center frequency of a second frequency band in which a receiver receives the signal, and controlling, by the communication apparatus, transmission in the first frequency band or reception in the second frequency band based on the information.

One aspect of the present disclosure is useful for a wireless communication system.

What is claimed is:

1. A communication apparatus comprising:
a reception circuitry which, in operation, receives information regarding at least one of a first center frequency of a first frequency band in which a transmitter transmits a signal and a second center frequency of a second frequency band in which a receiver receives the signal; and
a control circuitry which, in operation, controls transmission in the first frequency band or reception in the second frequency band based on the information.

2. The communication apparatus according to claim 1, wherein
the communication apparatus is the transmitter,
the reception circuitry, in operation, receives the information regarding the second center frequency from the receiver, and
the control circuitry, in operation, controls transmission of the signal in a frequency resource different from the second center frequency.

3. The communication apparatus according to claim 1, wherein
the communication apparatus is the transmitter,
the reception circuitry, in operation, receives the information regarding the second center frequency from the receiver, and
the control circuitry, in operation, does not map the signal to a frequency resource corresponding to the second center frequency, and maps the signal to another frequency resource different from the frequency resource corresponding to the second center frequency.

4. The communication apparatus according to claim 1, wherein
the communication apparatus is the transmitter,
the communication apparatus further comprises a transmission circuitry,
the reception circuitry, in operation, receives the information regarding the second center frequency from the receiver,
the transmission circuitry, in operation, transmits the information regarding the first center frequency to the receiver, and
the control circuitry, in operation, does not map the signal to frequency resources corresponding to the first center frequency and the second center frequency, and maps the signal to other frequency resources different from the frequency resources corresponding to the first center frequency and the second center frequency.

5. The communication apparatus according to claim 1, wherein
the communication apparatus is the receiver,
the reception circuitry, in operation, receives the information regarding the first center frequency from the transmitter, and
the control circuitry, in operation, controls reception of the signal in a frequency resource different from the first center frequency.

6. The communication apparatus according to claim 1, wherein
the communication apparatus is the receiver,
the reception circuitry, in operation, receives the information regarding the first center frequency from the transmitter, and
the control circuitry, in operation, does not use a frequency resource corresponding to the first center frequency for reception processing, and uses another frequency resource different from the frequency resource corresponding to the first center frequency for reception processing.

7. The communication apparatus according to claim 1, wherein
the communication apparatus is the receiver,
the communication apparatus further comprises a transmission circuitry,
the reception circuitry, in operation, receives the information regarding the first center frequency from the transmitter,
the transmission circuitry, in operation, transmits the information regarding the second center frequency to the transmitter, and
the control circuitry, in operation, does not use frequency resources corresponding to the first center frequency and the second center frequency for reception processing, and uses other frequency resources different from the frequency resources corresponding to the first center frequency and the second center frequency for reception processing.

8. The communication apparatus according to claim 1, wherein
the communication apparatus is the transmitter,
the reception circuitry, in operation, receives information regarding a reception signal at the first center frequency from the receiver, and
the control circuitry, in operation, corrects a transmission circuitry of the transmitter based on the information regarding the reception signal.

9. The communication apparatus according to claim 8, wherein the information regarding the reception signal includes reception quality at the first center frequency, a value indicating interference at the first center frequency, or a correction amount of the transmission circuitry.

10. The communication apparatus according to claim 8, wherein the control circuitry, in operation, performs correction processing of suppressing LO leakage or correction processing of correcting a DC offset at a transmission center frequency of the transmitter based on the information regarding the reception signal.

11. The communication apparatus according to claim 1, wherein
the communication apparatus is the transmitter,
the communication apparatus further comprises a transmission circuitry,
the transmission circuitry, in operation, transmits the information regarding the first center frequency to the receiver,
the reception circuitry, in operation, receives information regarding a reception signal at the first center frequency from the receiver, and
the control circuitry, in operation, corrects a characteristic of the transmission circuitry based on the information regarding the reception signal.

12. A communication method comprising:
receiving, by a communication apparatus, information regarding at least one of a first center frequency of a first frequency band in which a transmitter transmits a signal and a second center frequency of a second frequency band in which a receiver receives the signal; and
controlling, by the communication apparatus, transmission in the first frequency band or reception in the second frequency band based on the information.
